(19) United States
(12) Patent Application Publication
(10) Pub. No.: US 2015/0187299 A1
(43) Pub. Date: Jul. 2, 2015

(54) Method for Collecting Full Grayscale Data of LCD Based On CCD Camera

(71) Applicant: Shenzhen China Star Optoelectronics Technology Co. Ltd., Shenzhen, Guangdong (CN)

(72) Inventors: Jinjun Wu, Shenzhen City (CN); Chih-tsung Kang, Shenzhen City (CN)

(21) Appl. No.: 14/235,007

(22) PCT Filed: Jan. 7, 2014
(86) PCT No.: PCT/CN2014/070222

§ 371 Date: Jan. 24, 2014

(30) Foreign Application Priority Data
Dec. 31, 2013 (CN) 201310752429.1

(51) Int. Cl. G09G 3/36; G09G 3/20

(52) U.S. Cl. CPC G09G 3/3648; G09G 3/2003; G09G 2320/0666

(57) ABSTRACT

The present invention provides a method for collecting full grayscale data of a liquid crystal display device based on a CCD camera, the method including the steps of: S1, displaying a full grayscale image on a liquid crystal display device; S2, having the CCD camera to perform an automatic exposure toward the displayed full grayscale image of the LCD, and then collecting data of full grayscale thereof; and S3, conducting a compensation process toward the collected full grayscale data. With the utilization of the CCD camera, the full grayscale brightness and colorfulness data of the LCD can be readily collected by the CCD camera, and only a single image is needed to attain the full grayscale data. The speed is really fast. With afterward compensation to the data collected by the CCD camera, the accuracy of the data attained by the CCD camera is further increased. The method provided by the present invention can be readily implemented onto a production line so as to quickly collect data and determine whether the brightness and colorfulness is within the specifications, or a modification is needed based on the collected data. The speed is fast. As a result, the loss resulted from the brightness and colorfullness variations out of the specification can be readily reduced.

### FIELD OF THE INVENTION

The present invention relates to a technical field of data processing in liquid crystal display, and more particularly, to a method for collecting full grayscale data of the liquid crystal display based on CCD camera.

Currently, CA310 analyzer, CS2000 and SRUL2 spectral radiance meters have been used to collect the full grayscale brightness and colorfulness data. It features that the 0˜255 full grayscale can be automatically switched on the screen, and then collect the data. However, it has also the following defects. The collecting speed is very slow, and normally it takes about several minutes. In laboratory or production line, the data of full grayscale brightness and colorfulness has to be quickly determined so as to adjust the optical code or to determine whether the brightness or colorfulness are within the specifications.

CCD camera can collect the data of brightness and colorfulness in different positions of an image. However, different brightness needs different exposure time so as to attain the accurate data. With a uniformed exposure time, the data of brightness collected are inaccurate. In addition, the uniformness of brightness and chroma of the LCD panel will also affect the collection of the data.

Accordingly, in addressing the technical problem encountered, it is really necessary to have a method to collect full grayscale image data of the liquid crystal display based on CCD camera available to the market.

### SUMMARY OF THE INVENTION

In light of this, it is an object of the present invention to provide a method for collecting full grayscale image data of the liquid crystal display based on CCD camera. With the provision of the method, only a single image is needed from the module. Different positions of the image will display different grayscale brightness. This method features a fast process and takes only few seconds.

In order to achieve the object set forth above, the present invention provides a technical solution disclosed below.

A method for collecting full grayscale data of a liquid crystal display device based on a CCD camera, the method including the steps of:

S1, displaying a full grayscale image on a LCD;

S2, having the CCD camera to perform an automatic exposure toward the displayed full grayscale image of the LCD, and then collecting data of full grayscale thereof; and

S3, conducting a compensation process toward the collected full grayscale data.

As to a further improvement of the present invention, wherein the full grayscale data includes full grayscale brightness data and full grayscale colorfulness data.

As to a further improvement of the present invention, wherein the full grayscale image is an image configured with rectangular patterns arranged in array

As to a further improvement of the present invention, wherein dimension of the rectangular pattern is 1:16 compared to dimension of the liquid crystal display device.

As to a further improvement of the present invention, the full grayscale image is in an image with different values of grayscale in different positions having equal distance to a center of the liquid crystal display device.

As to a further improvement of the present invention, wherein the full grayscale image is a circular pattern, collar pattern, or polygonal pattern.

As to a further improvement of the present invention,

As to a further improvement of the present invention, wherein the step S3 substantially includes the sub-steps of:

S31, collecting, separately, a full grayscale image data from the CCD camera, and a full grayscale image data with a color analyzer so as to calculate coefficient of compensation for the CCD camera and the color analyzer; and

S32, performing a compensation process to the collected full grayscale image data from the CCD camera based on the coefficient of compensation thereafter.

As to a further improvement of the present invention, wherein the coefficient of compensation in sub-step of S31 is defined by the formula of:

coefficient of compensation=full grayscale image data collected by CCD camera/full grayscale image data collected by color analyzer.

As to a further improvement of the present invention, wherein the sub-step of S32 is substantially embodied as following:

dividing the full grayscale image collected by the CCD camera with the coefficient of compensation so as to attain the compensated full grayscale image.

The present invention is benefited with the following advantages.

With the utilization of the CCD camera, the full grayscale brightness and colorfulness data of the LCD can be readily collected by the CCD camera, and only a single image is needed to attain the full grayscale data. The speed is really fast.

With afterward compensation to the data collected by the CCD camera, the accuracy of the data attained by the CCD camera is further increased.

The method provided by the present invention can be readily implemented onto a production line so as to quickly collect data and determine whether the brightness and colorfulness is within the specifications, or a modification is needed based on the collected data. The speed is fast. As a result, the loss resulted from the brightness and colorfullness variations out of the specification can be readily reduced.

### BRIEF DESCRIPTION OF DRAWINGS

In order to give a better and thorough understanding to the whole and other intended purposes, features and advantages of the technical solution of the present invention, detailed description will be given with respect to preferred embodiments provided and illustrated herebelow in accompanied drawings. Apparently, with the spirit of the embodiments disclosed, person in the skilled in the art can readily come out with other modifications as well as improvements without undue experiment. In addition, other drawings can be readily achieved based on the disclosed drawings. Wherein

FIG. 1 is a flow chart diagram illustrating a substantial steps of a method for collecting full grayscale image data of the liquid crystal display based on CCD camera;

FIG. 2a is an illustrational view of a full grayscale image made in accordance with a first embodiment of the present invention, FIGS. 2b and 2c are illustrational view showing the distributions of the value of the full grayscale image;

FIGS. 3a-3c are illustrational views of three full grayscale image used in the first embodiment;

FIG. 4 is a comparison between the brightness of the full grayscale image collected by the CA310 color analyzer and the CCD camera;

FIGS. 5a-5c are illustrational views of three full grayscale image used in the second embodiment;

FIG. 6 is a comparison between the brightness of the full grayscale image collected by the CA310 color analyzer and the CCD camera;

FIGS. 7a, 7b and 7c are comparison between data, full grayscale brightness Lv, full grayscale colorfulness x, and full grayscale colorfulness y, collected by the CA310 color analyzer and the CCD camera, respectively; and

FIGS. 8a, 8b and 8c are comparison between data, full grayscale brightness Lv, full grayscale colorfulness x, and full grayscale colorfulness y, collected by the CA310 color analyzer and the CCD camera, respectively.

### DETAILED DESCRIPTION OF PREFERRED EMBODIMENTS

In order clearly explain the technology of the embodiment illustrated in the present invention, a brief and concise description will be given along with the accompanied drawings. Apparently, the embodiments illustrated in the drawings are merely some typical embodiments and which can be readily modified by the skilled in the art without any additional laborious efforts so as to transform them into other drawings, and they should all be covered by the appended claims.

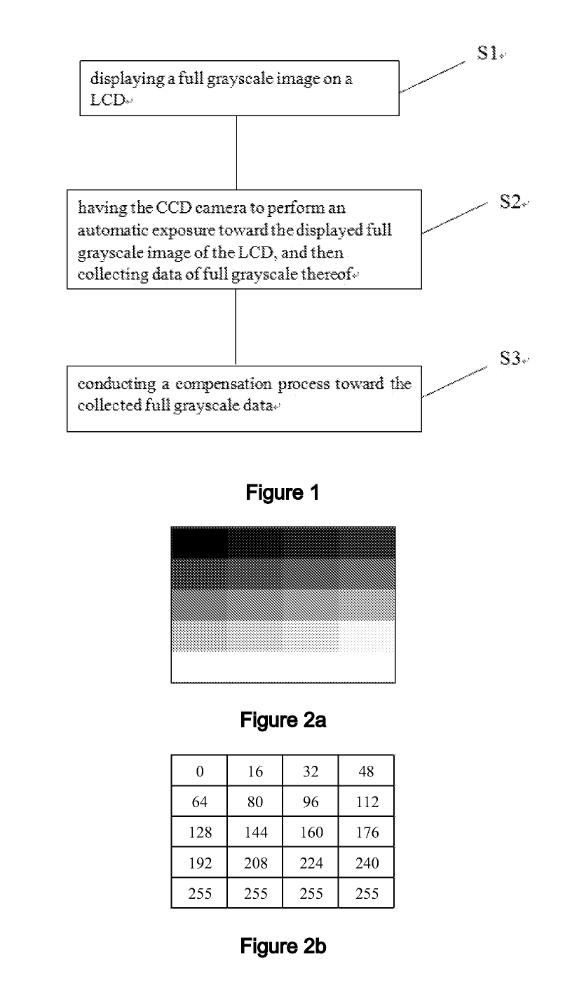

Referring to FIG. 1, a method for collecting full grayscale image data of the liquid crystal display based on CCD cam made in accordance with the present invention includes the following steps:

S1, displaying a full grayscale image on a liquid crystal display device;

S2, having the CCD camera to perform an automatic exposure toward the displayed full grayscale image of the LCD, and then collecting data of full grayscale thereof; and wherein the full grayscale data includes full grayscale brightness data and full grayscale colorfulness data.

S3, conducting a compensation process toward the collected full grayscale data.

Wherein the full grayscale image is an image configured with rectangular patterns arranged in array, or wherein the full grayscale image is in an image with different values of grayscale in different positions having equal distance to a center of the LCD panel, such as a circular image, an annulus shaped image or a polygonal image.

Wherein the step S3 substantially includes the sub-steps of:

S31, collecting, separately, a full grayscale image data from the CCD camera, and a full grayscale image data with a color analyzer so as to calculate coefficient of compensation for the CCD camera and the color analyzer; and wherein the coefficient of compensation in sub-step of S31 is defined by the formula of:

coefficient of compensation=full grayscale image data collected by CCD camera/full grayscale image data collected by color analyzer.

S32, performing a compensation process to the collected full grayscale image data from the CCD camera based on the coefficient of compensation thereafter.

In the existing technology, the color analyzer CA310 is to let the LCD automatically to switch between 0-255 full grayscale screen, and the collecting the brightness and colorfulness data of the LCD. The timing is comparably slow. In order to overcome this, the CCD camera implemented in the present invention take only a screen shot to capture the patterns of grayscale located on different positions on the screen. Then, a calculation is made to attain the brightness and colorfulness data. The data is modified and then compared with the actual data collected by the CA310 color analyzer. The data collected by the present invention is very close to the data attained by the CA310 color analyzer, while it only takes about five (5) seconds to attain the full grayscale data. As a result, the present invention is suitable applied onto the production line.

Embodiments will be given to further illustrate and elaborate the spirit of the present invention.

### Embodiment I

S1, displaying a full grayscale image on a liquid crystal display device such as shown in FIG. 2a. In the current embodiment, the full grayscale image is an image arranged in array, such as depicted in FIG. 2b. In FIG. 2a, the value of grayscale from dark to bright is marked as 0, 16, 32, . . . , 240, 255.

S2, having the CCD camera to perform an automatic exposure toward the displayed full grayscale image, and then collecting the data of brightness and colorfulness of full grayscale of the LCD.

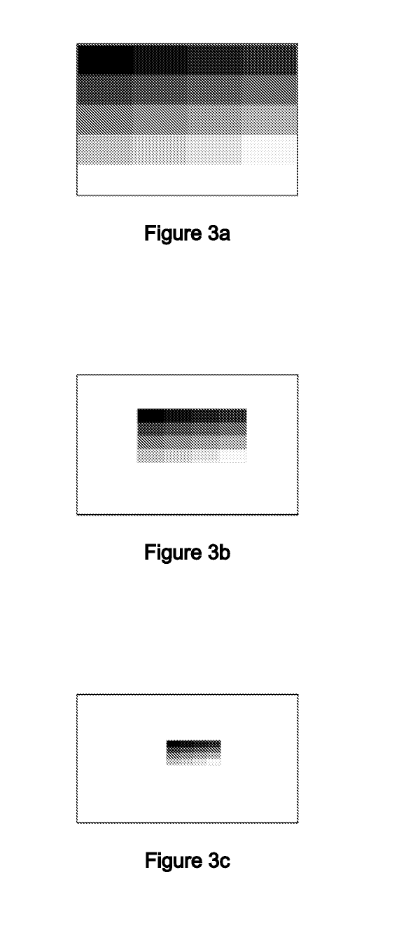

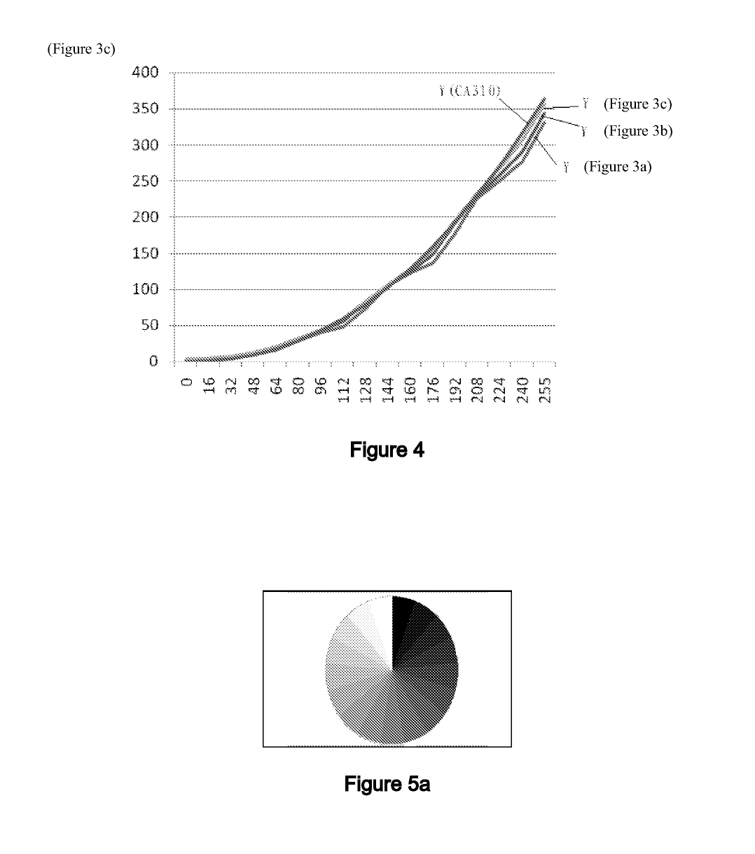

In considering the influence of the uniformness of brightness and chroma of the LCD panel, theoretically, the smaller the dimension of the full grayscale image, the smaller the impact from the uniformness of brightness and chroma of the LCD to the collected data. Accordingly, a verification to the images depicted in FIGS. 3a˜3c is performed. The size or dimension of the full grayscale image shown in FIGS. 3a-3c is decreased from full screen, one fourth (¼) of the screen, and one sixteenth ( 1/16) of the screen.

In addition, since the exposure time of the CCD camera can only be set to a certain value, and after try-and-error, it is concluded that the exposure time attained by an automatic exposure time to FIG. 2a is comparably better. However, some of the values of the data of the grayscale may be inaccurate. In order to verify the accuracy of the data collected by the CCD camera, CA310 color analyzer is used to serve as a standardized value in collecting the full grayscale data in the center.

The reference result is disclosed in FIG. 4. Regarding to the brightness curve, accurate data results more smooth curve, such as illustrated by the CA310, while the data collected by the CCD camera has some bends in view of the brightness curve. As shown in

FIGS. 3a, 3b and 3c, the bends on those three Figures are all located on the same grayscale, and it is because of the different grayscale images having different distance to the center, i.e. the uniformness of brightness and chroma of the LCD panel imposes an effect on this. However, the smaller the full grayscale image, the illegible of the bend, and the abnormal data variation is also reduced.

### Embodiment II

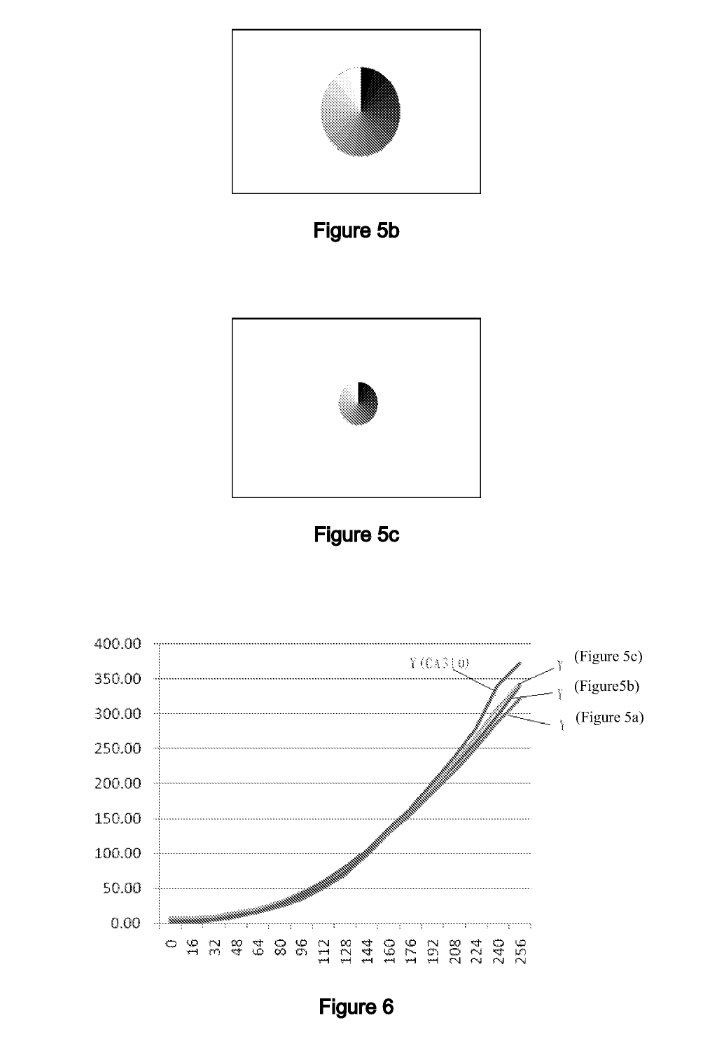

In example I, the data collected has some abnormal variations, and it is because different grayscale has different distance to a center. Accordingly, in order to attain accurate data, different grayscale has to have equal distance to the center. As a result, the data should be collected from an image, such as a circular or annulus shaped image, which has the same grayscale to the center from all position. Circle, annulus, polygonal shaped images are all acceptable. As a result, theoretically, the abnormal variations of the data can be eliminated in Example I. In addition, the smaller the image, the closer to the center, the fewer the abnormal variation is. Now, an example will be demonstrated by taking a photo with a circular shaped image. Referring to FIGS. 5a, 5b and 5c, each depicts a circular shaped image with smaller diameter, which equals to one half (½), one fourth (¼), and one eighth (⅛) of the width of the LCD.

The method for collecting data in the Example II is similar to Example I, and the only difference resides on the full grayscale image. The value of grayscale from dark to bright is marked as 0, 16, 32, . . . , 240, 255; and a comparison diagram illustrating the data, corresponding the large size, middle size and small size of circular images, collected from the CA310 color analyzer and the CCD camera are respectively disclosed in FIG. 6. It can be readily seen from FIG. 6 that when collecting data from the circular images, the abnormal bends on the data line on Example I is readily removed. In addition, the data collected from the smaller circular image is more accurate than the data collected from the larger circular image. Accordingly, the data collecting process conducted thereafter will be focused on the smaller circular shape shown in FIG. 5c. It can be readily appreciated that when using other shapes, such as annulus shape and polygonal shapes, which has the same distance to the center can also reach the same result. As a result, no detailed description is given.

Hereinafter, brightness and colorfulness data will be collected with the CCD camera based on the circular image shown in FIG. 5c in every sixteen (16) increments. Then, the collected data will be further calculated to attain the full grayscale data. The calculated data will further compared with the data collected by CA310 at the center.

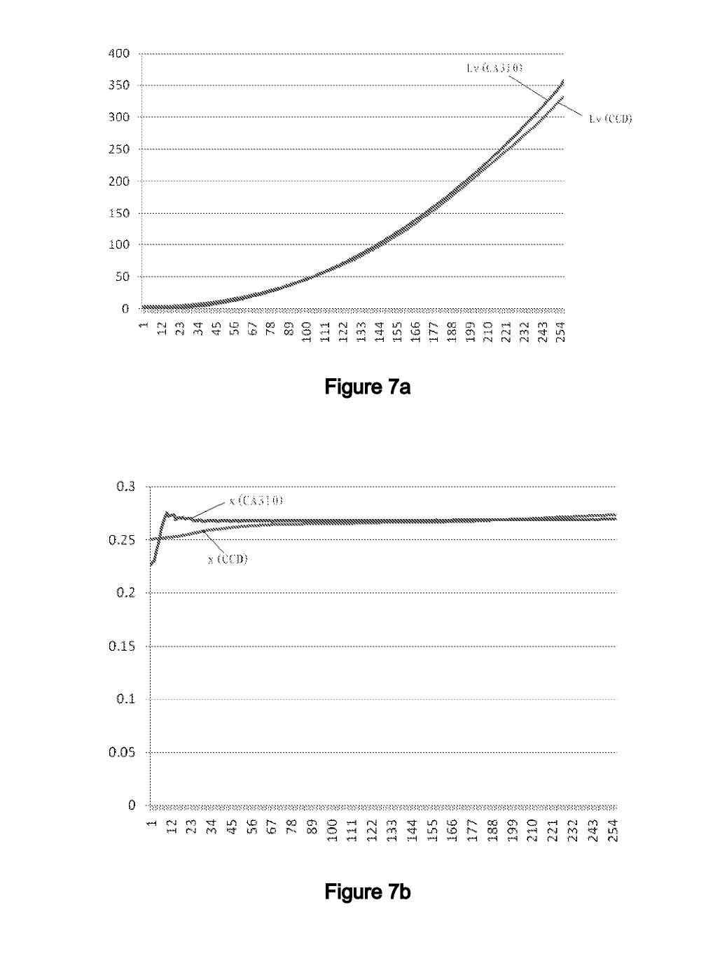

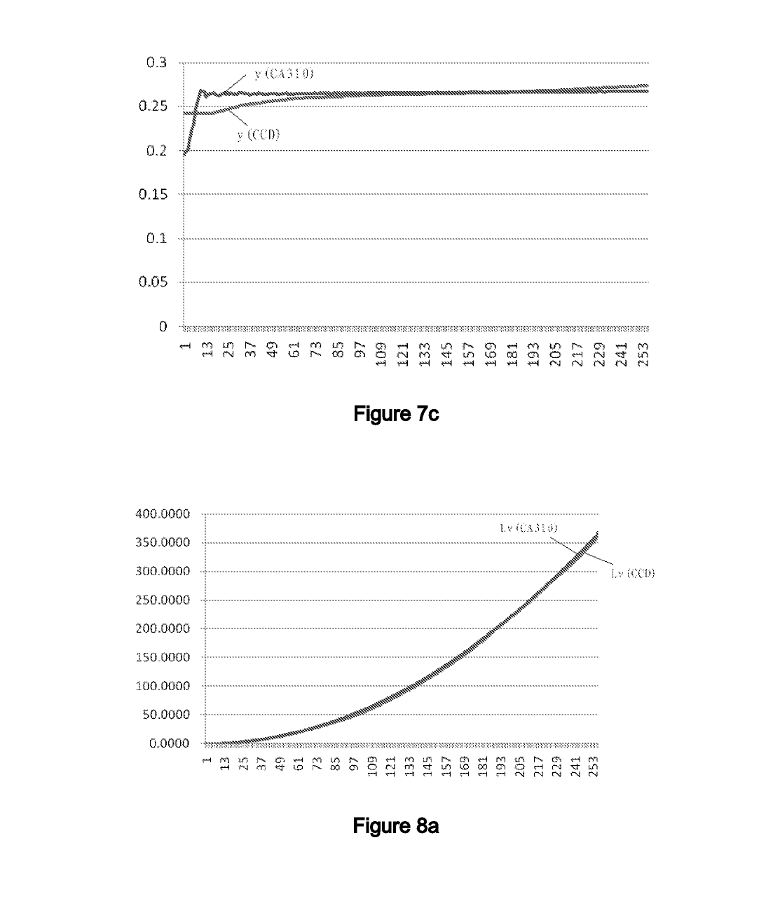

Referring to FIGS. 7a, 7b and 7c, comparison diagrams between data, full grayscale brightness Lv, full grayscale colorfulness x, and full grayscale colorfulness y, collected by the CA310 color analyzer and the CCD camera, respectively. It can be readily appreciated that the brightness data from the CCD camera has not shown any abnormal bend as found in Example I. Accordingly, this embodiment is more accurate than the Example I.

### Embodiment III

Referring to FIGS. 7a, 7b and 7c, in collecting the data, the middle to high grayscale colorfulness data collected by CA310 color analyzer is generally remained unchanged, while the value of the colorfulness data collected by the CCD camera keeps increasing. The difference is comparably large in the low grayscale. There is also a difference on the brightness. In light of this, a corresponding relationship between the data collected by CA310 color analyzer and the CCD camera has to be found out, and further performing a modification. The method for collecting full grayscale data of a liquid crystal display device based on a CCD camera, the method including the steps of:

S1, displaying a full grayscale image on a liquid crystal display device;

S2, having the CCD camera to perform an automatic exposure toward the displayed full grayscale image of the LCD, and then collecting data of full grayscale thereof; and

S3, conducting a compensation process toward the collected full grayscale data.

Wherein the steps S1 and S2 are identical to the steps S1 and S2 performed in the Embodiment 2, as a result, no detailed description is given herebelow. The step S3 substantially includes the sub-steps of:

S31, collecting, separately, a full grayscale image data from the CCD camera, and a full grayscale image data with a color analyzer so as to calculate coefficient of compensation for the CCD camera and the color analyzer; and wherein the coefficient of compensation in sub-step of S31 is defined by the formula of:

coefficient of compensation=full grayscale image data collected by CCD camera/full grayscale image data collected by color analyzer.

S32, performing a compensation process to the collected full grayscale image data from the CCD camera based on the coefficient of compensation thereafter. The method of compensating is to divide the full grayscale image collected by the CCD camera with the coefficient of compensation so as to attain the compensated full grayscale image data. By this arrangement, a more accurate data can be readily attained by modifying the data attained by the CCD camera.

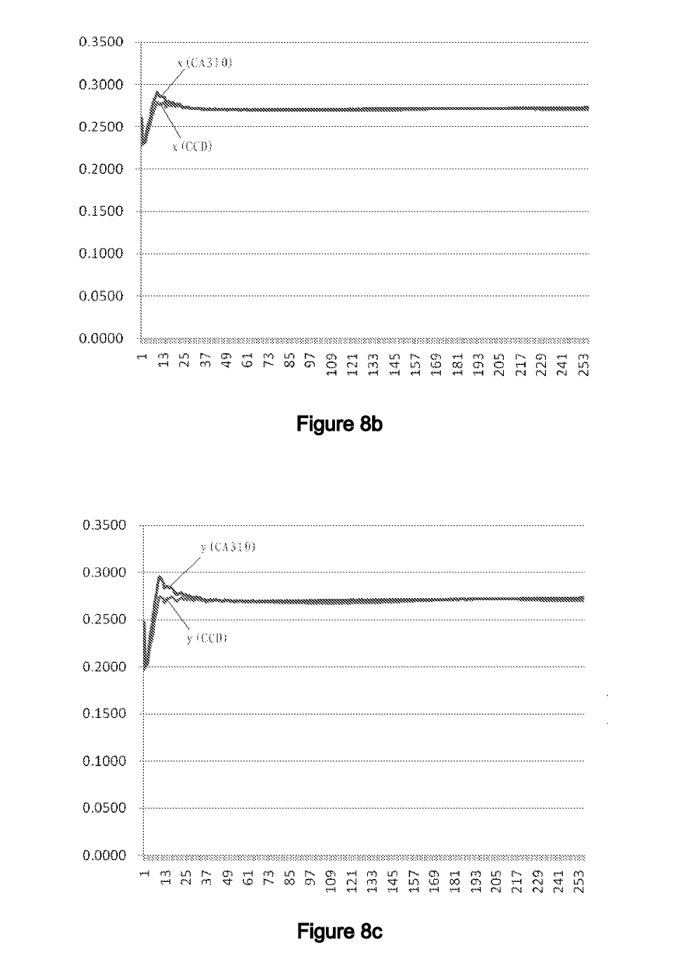

Referring to FIGS. 8a, 8b and 8c, comparison diagrams between data, full grayscale brightness Lv, full grayscale colorfulness x, and full grayscale colorfulness y, collected by the CA310 color analyzer and the CCD camera, respectively. It can be readily appreciated that the data collected by the CCD camera can be further compensated so as to further closer to the data collected by the CA310 color analyzer. However, it should be noted that the proportional rate of the compensation to each grayscale will be affected by the brightness.

From the description to the forgoing embodiments, it can be readily appreciated that the present invention can reach the following advantages.

With the utilization of the CCD camera, the full grayscale brightness and colorfulness data of the LCD can be readily collected by the CCD camera, and only a single image is needed to attain the full grayscale data. The speed is really fast.

With afterward compensation to the data collected by the CCD camera, the accuracy of the data attained by the CCD camera is further increased.

The method provided by the present invention can be readily implemented onto a production line so as to quickly collect data and determine whether the brightness and colorfulness is within the specifications, or a modification is needed based on the collected data. The speed is fast. As a result, the loss resulted from the brightness and colorfullness variations out of the specification can be readily reduced.

To the skilled in the art, it should be readily appreciated that the present invention should not be limited to details of those embodiments, while it can be readily implemented in different manners and ways without departing the spirit and characteristic of the present invention. Accordingly, it should be noted that those embodiments are merely illustrative instead of limitations from any aspects, and the scope of the present invention is defined by the appended claims instead of those embodiments. Any variations and modifications within the spirit and characteristics of the present invention should be covered by the present invention. Any description and reference made in the drawings should not impose any limitations of the present invention.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

1. A method for collecting full grayscale data of a LCD based on a CCD camera, the method including the steps of:
S1, displaying a full grayscale image on a LCD;
S2, having the CCD camera to perform an automatic exposure toward the displayed full grayscale image of the LCD, and then collecting data of full grayscale thereof; and
S3, conducting a compensation process toward the collected full grayscale data.

2. The method as recited in claim 1, wherein the full grayscale data includes full grayscale brightness data and full grayscale colorfulness data.

3. The method as recited in claim 1, wherein the full grayscale image is an image configured with rectangular patterns arranged in array.

4. The method as recited in claim 3, wherein dimension of the rectangular pattern is 1:16 compared to dimension of the LCD.

5. The method as recited in claim 1, wherein the full grayscale image is in an image with different values of grayscale in different positions having equal distance to a center of the LCD panel.

6. The method as recited in claim 5, wherein the full grayscale image is a circular pattern, collar pattern, or polygonal pattern.

7. The method as recited in claim 6, wherein the distance of the full grayscale image with different values of grayscale in different positions to the center of the liquid crystal display device ranges from one eighth (⅛) to one half (½) of width of the LCD panel.

8. The method as recited in claim 1, wherein the step S3 substantially includes the sub-steps of:
S31, collecting, separately, a full grayscale image data from the CCD camera, and a full grayscale image data with a color analyzer so as to calculate coefficient of compensation for the CCD camera and the color analyzer; and
S32, performing a compensation process to the collected full grayscale image data from the CCD camera based on the coefficient of compensation thereafter.

9. The method as recited in claim 8, wherein the coefficient of compensation in sub-step of S31 is defined by the formula of:
coefficient of compensation=full grayscale image data collected by CCD camera/full grayscale image data collected by color analyzer.

10. The method as recited in claim 8, wherein the sub-step of S32 is substantially embodied as following:
dividing the full grayscale image collected by the CCD camera with the coefficient of compensation so as to attain the compensated full grayscale image data.
